(19) United States
(12) Patent Application Publication
(10) Pub. No.: US 2017/0373517 A1
(43) Pub. Date: Dec. 28, 2017

(54) AIRFLOSS DOCKING STATION CHARGE DETECTION

(71) Applicant: KONINKLIJKE PHILIPS N.V., EINDHOVEN (NL)

(72) Inventors: BRIAN JOHANSKI, SNOHOMISH, WA (US); SAHAR BIN HAIRALAH, SAMMAMISH, WA (US); PAUL ANDERSON, HONG KONG (CN)

(21) Appl. No.: 15/540,060

(22) PCT Filed: Dec. 23, 2015
(86) PCT No.: PCT/IB2015/059905

§ 371 Date: Jun. 27, 2017

Related U.S. Application Data
(60) Provisional application No. 62/097,253, filed on Dec. 29, 2014.

(51) Int. Cl. H02J 7/00; A61C 15/00; A61C 17/02; H02J 7/02

(52) U.S. Cl. CPC H02J 7/0047; H02J 7/025; H02J 7/0044; A61C 15/00; A61C 17/0202; A61C 17/0217

(57) ABSTRACT

An oral cleaning system for communicating a status of a handheld oral cleaning device (10) to a docking station (100). The handheld oral cleaning device includes a controller (70) configured to generate a unique charging cycle for each of a plurality of different charging states. The docking station (100) is configured to receive the handheld oral cleaning device, and includes a secondary charging induction coil configured to detect the unique charging cycle for each of the plurality of different charging periods. The docking station further includes a visual indicator (120) configured to indicate, based on the detected charging cycle, one of the plurality of different charging states of the handheld oral cleaning device.

### FIELD OF THE INVENTION

The present disclosure is directed generally to methods and systems for communicating a status of a handheld oral cleaning device to a docking station.

### BACKGROUND

Periodontal diseases are thought to be infectious diseases caused by bacteria present in dental plaques and biofilms. Removal of dental plaques and biofilms is highly important for the health of oral cavities. Tooth brushing is a highly effective method to remove dental plaque and biofilms from the teeth, provided the oral cleaning device is actually used in such a fashion to reach all areas where plaque resides.

For example, oral cleaning devices that clean the teeth with streams or bursts of liquid or a mixture of liquid droplets and air are effective at disrupting dental plaques and biofilm in the oral cavity, particularly in the interproximal areas of the teeth. These devices generally create liquid droplets when the liquid is brought into contact with a high velocity stream of air using a pump or similar arrangement. Coordinated bursts of liquid and air use far less liquid per cleaning compared to a continuous stream of liquid, and provide superior dental plaques and biofilm removal and interdental cleaning. One such device for home use is the Philips Sonicare AirFloss® flosser (manufactured by Koninklijke Philips Electronics, N.V.). While the system is effective, the fluid chamber in the handheld oral cleaning device requires intermittent refilling with water, mouthwash, or other fluid. In certain embodiments of the handheld oral cleaning device, it can be difficult to see the current level or remaining fluid in the fluid chamber. An easier notification and filling method would be advantageous.

Accordingly, there is a need in the art for a mechanism for quickly and efficiently refilling a handheld oral cleaning device while also enabling charging of the handheld device and notifying the user of the charge state of the handheld device.

### SUMMARY OF THE INVENTION

The present disclosure is directed to inventive methods and systems for communicating a status of a handheld oral cleaning device to a docking station. Various embodiments and implementations herein are directed to a docking station and an oral cleaning device, the docking station comprising a charging base for recharging the handheld oral cleaning device, a visual indicator to indicate the charge state of the handheld oral cleaning device docked into the docking station, a reservoir for holding a larger amount of fluid than can be held in the handheld oral cleaning device, and a mechanism for automatically refilling the fluid chamber on the handheld oral cleaning device from the larger reservoir on the docking station when the handheld oral cleaning device is mounted into the docking station. The docking station utilizes charge line pulses to determine and communicate the charge state of the handheld oral cleaning device. Since the display on the handheld oral cleaning device is not visible when the device is secured into the docking station for charging and/or refilling, the docking station includes a display to indicate the determined charging status of the handheld oral cleaning device.

Generally, in one aspect, an oral cleaning system is provided. The oral cleaning system includes: a handheld oral cleaning device comprising a controller configured to generate a unique charging cycle for each of a plurality of different charging states; and a docking station configured to receive the handheld oral cleaning device, the docking station comprising a secondary charging induction coil configured to detect the unique charging cycle for each of the plurality of different charging periods, and further comprising a visual indicator configured to indicate, based on the detected charging cycle, one of the plurality of different charging states of the handheld oral cleaning device.

According to an embodiment, the plurality of different charging states of the handheld oral cleaning device includes at least one of a start of charge state, a charging state, and an end of charge state.

According to an embodiment, an on and off timing interval for the charging cycle of each of the plurality of different charging states is unique.

According to an embodiment, the visual indicator provides a different indication for each of the plurality of different charging states of the handheld oral cleaning device. For example, the visual indicator can illuminate with a different color for each of the plurality of different charging states of the handheld oral cleaning device, among other indications.

According to an embodiment, the handheld oral cleaning device comprises a charging mechanism, the charging mechanism comprising an induction coil configured to generate the unique charging cycles.

According to an embodiment, the docking station further comprises a liquid reservoir.

According to an aspect, a docking station configured to receive a handheld oral cleaning device is provided. The docking station includes a liquid reservoir; a charging mechanism configured to charge the handheld oral cleaning device, the charging mechanism comprising a secondary charging induction coil configured to detect a unique charging cycle for each of a plurality of different charging periods of the handheld oral cleaning device; and a visual indicator configured to indicate, based on the detected charging cycle, one of the plurality of different charging states of the handheld oral cleaning device.

According to another aspect, a handheld oral cleaning device is provided. The handheld oral cleaning device is configured to be charged when docked with a docking station, and includes: a nozzle; a handle; a charging mechanism; and a controller in communication with the charging mechanism, the controller configured to generate a unique charging cycle for each of a plurality of different charging states, wherein the plurality of different charging states comprises at least one of a start of charge state, a charging state, and an end of charge state.

According to an embodiment, the device is configured to communicate the generated unique charging cycle to the docking station via the charging mechanism.

As used herein for purposes of the present disclosure, the term “controller” is used generally to describe various apparatus relating to the operation of a ventilator apparatus, system, or method. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

These and other aspects of the invention will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a view of a handheld oral cleaning device, in accordance with an embodiment.

FIG. 2A is a side view of a docking station with a hand-held appliance mounted thereon for refilling and charging, in accordance with an embodiment.

FIG. 3A is a graph of a charging cycle of a prior art handheld oral cleaning device when mounted in a standard charger.

FIG. 3B is a graph of a charging cycle of a handheld oral cleaning device when mounted in the docking station disclosed herein, in accordance with an embodiment.

FIG. 4 is a diagram of a communication protocol specification between a handheld oral cleaning device and a docking station, in accordance with an embodiment.

FIG. 5 is a circuit diagram of a charging signal detection module, in accordance with an embodiment.

FIG. 6 is a flowchart of a method for communicating a status of a handheld oral cleaning device to a docking station, in accordance with an embodiment.

### DETAILED DESCRIPTION OF EMBODIMENTS

The present disclosure describes various embodiments of an oral cleaning system and method. More generally, Applicant has recognized and appreciated that it would be beneficial to provide a method and system for communicating a status of a handheld oral cleaning device to a docking station. The system includes a handheld oral cleaning device that cleans the teeth with streams or bursts of liquid or a mixture of liquid droplets and air, which is charged by docking into a docking station. The docking station of the system utilizes charge line pulses to determine and communicate the charge state of the handheld oral cleaning device, and includes a charging base for recharging the handheld oral cleaning device, a visual indicator to indicate the charge state of the handheld oral cleaning device.

The docking station system disclosed and described herein can be used with any oral care appliance for cleaning teeth using coordinated bursts of air and fluid. One example of such an oral care appliance that the docking station system can be used with is any Airfloss® device available from Koninklijke Philips Electronics N.V.

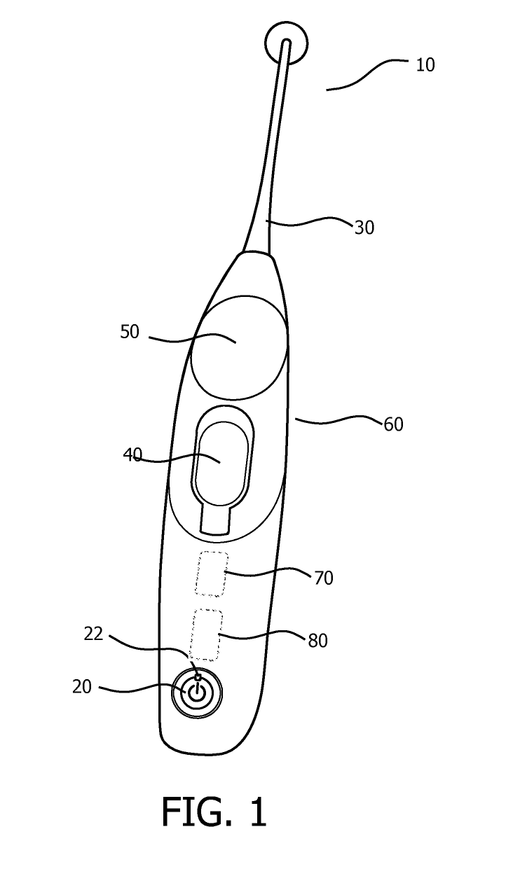

In view of the foregoing, various embodiments and implementations are directed to an oral cleaning system configure to communicate a status of a handheld oral cleaning device to a docking station. Referring to FIG. 1, in one embodiment, is a handheld oral cleaning device 10 configured to utilize a mechanical spring-drive system to produce a spray of liquid droplets which is used to clean the interproximal spaces between teeth. Handheld oral cleaning device 10 includes an outer housing which can be a plastic or other sufficiently hard or durable plastic. Handheld oral cleaning device 10 also includes a handle 60, and an elongated nozzle 30. The housing and/or handle 60 can be ergonomically sized and/or shaped to fit within a variety of hand sizes including children and adults. Handle 60 includes an actuation button 50 that activates the oral device and causes the delivery of a predetermined sequence of coordinated liquid bursts. During use the actuation button in this embodiment is most comfortably activated by pressing on the button with the thumb, but any finger could be used.

According to an embodiment of device 10, elongated nozzle 30 extends outwardly from the device and can have a curved portion at the distal end thereof, through which a spray of liquid droplets is directed for cleaning action against surfaces of the mouth. The curved portion assists in convenient positioning of the nozzle in the mouth by the user.

Device 10 also includes a chamber 40 for a liquid such as water, mouthwash, cleaning liquid, or other liquid. The chamber 40 is in communication with a liquid reservoir door or opening, through which liquid can be added to the reservoir. During operation, liquid in chamber 40 is mixed with air and propelled out through the nozzle. Although device 10 is described using a mechanical spring-drive system to create the selected liquid droplet spray mode for dental cleaning in this embodiment, other systems to create coordinated bursts of liquid and air are possible.

Handheld oral cleaning device 10 also includes a power button 20 used to turn the device on or off. According to an embodiment the power button includes a power/charge indicator 22, which can be illuminated, that is used to indicate that the hand-held device is on, or is being charged when the device is docked into a charger. For example, power/charge indicator 22 can comprise a variety of different colors to indicate power status and/or charge status, such as green to indicate charged and red to indicate low battery and/or a need to charge. The power/charge indicator 22 can alternatively comprise a series or scale of indicators, a lighted ring, bars, or other visual indicators.

Handheld oral cleaning device 10 also includes a device controller 70. The controller 70 can comprise a processor and a memory. The processor may take any suitable form, such as a microcontroller, plural microcontrollers, circuitry, a single processor, or plural processors. Controller 70 may be formed of one or multiple modules, and is operable to operate the oral cleaning device 10 in response to an input, for example user input. For example, controller 70 can be configured to actuate a motor control unit. As another example, controller 70 can be configured to control the charging cycle of handheld oral cleaning device 10.

The memory can take any suitable form, including a non-volatile memory and/or RAM. The non-volatile memory may include read only memory (ROM), a hard disk drive (HDD) or a solid state drive (SSD). The memory can store, among other things, an operating system. The RAM is used by the processor for the temporary storage of data. The operating system may contain code which, when executed by controller 70, controls operation of each of the hardware components of the oral cleaning device 10.

According to an embodiment, handheld oral cleaning device 10 comprises a rechargeable battery 80 in the base of the handle 60. For example, in an inductive charging mechanism, the handle includes a secondary coil that takes power from the electromagnetic field generated by the induction coil in the docking station, as described herein, and converts it back into electric current to charge the battery 80.

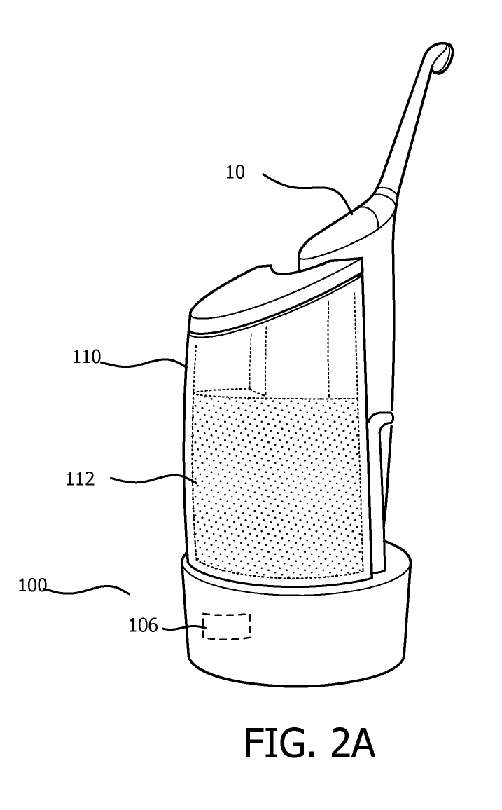

Referring to FIG. 2A, in one embodiment, is a docking station 100 for the handheld oral cleaning device 10. Docking station 100 includes a reservoir 110 for holding water, mouthwash, antimicrobial fluids, and/or other liquids 112. According to an embodiment, when device 10 is connected into the docking station, fluid from the docking station reservoir can be used to fill the chamber 40 on the device, as disclosed in a separate patent application filed contemporaneously with this application.

Docking station 100 also includes a mechanism for charging the handheld oral cleaning device when it is connected into the docking station. For example, the charging mechanism can include one or more charging contacts corresponding to one or more charging contacts on the handheld device. The charging mechanism can alternatively charge the device via contactless inductive coupling between the docking station 100 and the handheld oral cleaning device 10.

Referring to FIG. 2B, in one embodiment, is a top view of the docking station 100 into which handheld oral cleaning device 10 is docked. Docking station 100 includes a user interface or visual indicator 120 to indicate to a user whether the hand-held appliance is charged or charging. According to an embodiment, when device 10 is mounted into docking station 100, the power/charge indicator 22 on the device is not visible. Thus, the user cannot see whether the handheld oral cleaning device 10 is powered on, is charging, or needs charging when the device is docked into the docking station. Accordingly, docking station 100 has its own visual indicator 120 to indicate a status of the handheld oral cleaning device 10, including whether the device is charged, charging, and/or requires charging. As described herein, the docking station utilizes charge line pulses to determine the charge state of the handheld oral cleaning device, and utilizes the visual indicator 120 to communicate the charge status of the device when the device is docked into the docking station. The docking station visual indicator 120 can comprise a variety of different colors to indicate power status and/or charge status, such as green to indicate charged and red to indicate low battery and/or a need to charge. Docking station visual indicator 120 can alternatively comprise a series or scale of indicators, a lighted ring, bars, or any other visual indicator.

According to an embodiment, docking station 100 comprises a charging mechanism 106 in the base configured to hold the handheld cleaning device 10. For example, in an inductive charging mechanism, the docking station includes an induction coil that generates an electromagnetic field that is received by the secondary coil of the handheld cleaning device and utilized to charge the battery 80 of the device 10.

According to an embodiment, the oral cleaning system modifies the handheld oral cleaning device 10 to pulse or otherwise create patterns in its charge line binary on/off signal that correspond with its charge state, such as when the device is initially placed on the docking station charger, when the device is charging normally, when the device is trickle charging, and other statuses. As described herein, the docking station includes has a secondary induction coil with a signal that changes to correspond with the on/off state of the handheld oral cleaning device. Accordingly, docking station 100 can sense the charging state of device 10 by detecting and interpreting the signal from the secondary induction coil of the device.

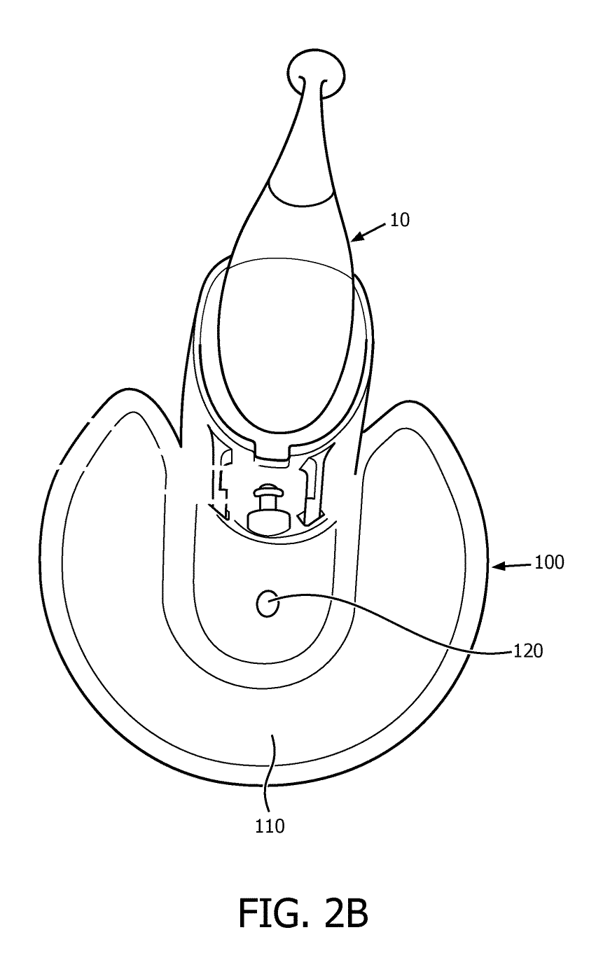

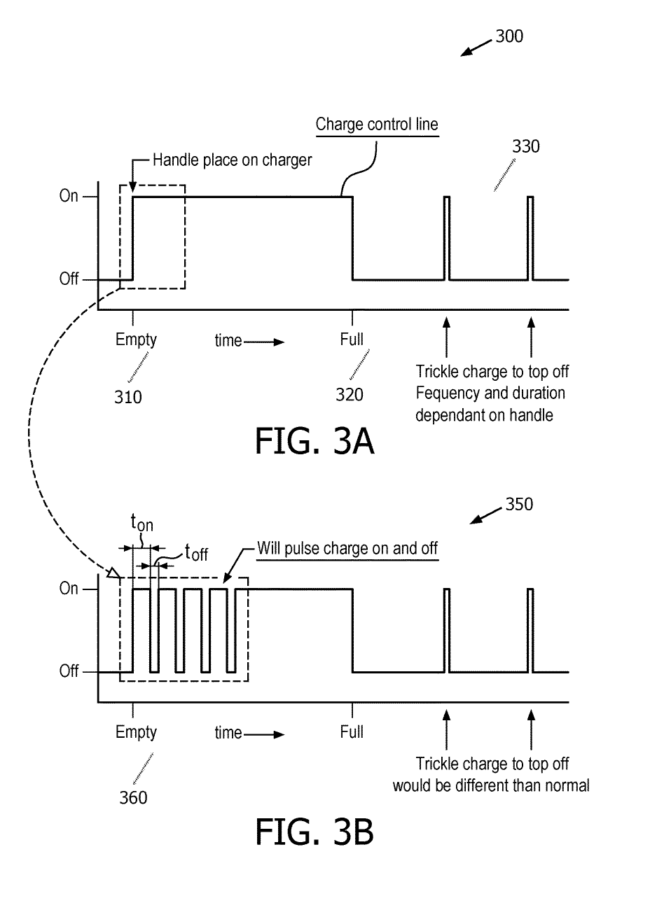

Referring to FIG. 3A, in one embodiment, is a graph 300 of a charging cycle of a handheld oral cleaning device when mounted in a prior art charger. When the handheld oral cleaning device is placed in the charging station at time 310, charging is initiated. The power on the charger stays in an ON state or CHARGE state until the battery 80 in the handheld device 10 is fully charged at time 320, at which point the charger returns to an OFF state. As long as the handheld device remains in the charging station, the charger will intermittently perform trickle charging 330 to top off the charge on the handheld device as needed.

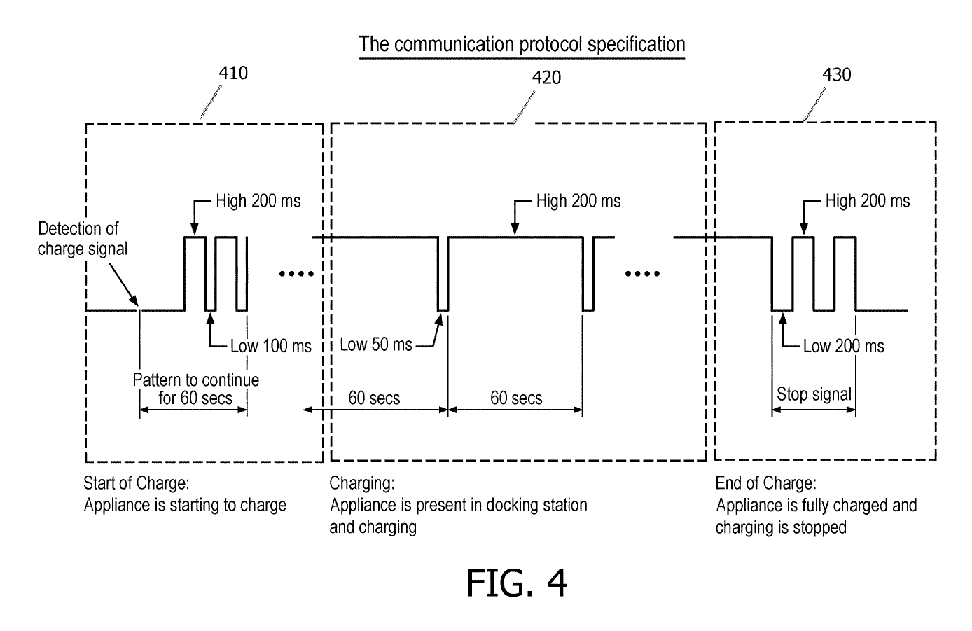

Referring to FIG. 3B, in one embodiment, is a graph 350 of a charging cycle of handheld oral cleaning device 10 when mounted in docking station 100. When device 10 is placed in docking station 100 at time 360, charging is initiated. According to this embodiment, when the handheld device is initially placed in docking station 100, the handheld device 10 will pulse the charge line on and off in a cycle that corresponds with its charge state, as shown in FIGS. 3B and 4. This initial pulsed on/off cycling will continue for a first time period 410 to indicate that the hand-held appliance is starting to charge. As shown in FIG. 4, this initial or start of charge on-off cycling pattern can continue for 60 seconds after the handheld device is placed in the docking station, although it can be appreciated that numerous other timing cycles can be used. As shown in FIG. 4, the start of charge cycle has a defined on and off timing cycle or pattern. The example shown in FIG. 4 is a 200 millisecond (ms) on or high interval, followed by a 100 ms low or off interval; however, it can be appreciated that other on/off timing and cycles are within the scope of the invention. According to an embodiment, the docking station 100 detects the pattern of the pulsed on/off cycling of handheld device 10 during the first time period 410, and conveys that information to a user via visual indicator 120.

At the end of the first time period, the power cycling on handheld device 10 will transition to a charging cycle with a different timing, which can continue for a second time period 420 until the battery 80 in the handheld device 10 is fully charged. An example of the second time period 420 is shown in FIG. 4. The charging cycle during second time period 420 in FIG. 4 is a 60 second charging cycle followed by a 50 ms off cycle, although again, other cycles with different timing are within the scope of the invention. The second time period will continue until the docking station detects that the handheld device is fully charged, or for a predetermined amount of time. According to an embodiment, the docking station 100 detects the pattern of the pulsed on/off cycling of handheld device 10 during the second time period 420, and conveys that information to a user via visual indicator 120.

When the handheld device is fully charged, the handheld device 10 will transition to an end of charge cycle during third time period 430. The charging cycle during third time period 430 in FIG. 4 is a 200 ms on period with a 200 ms off cycle, although again, other cycles with different timing are within the scope of the invention. The third time period will continue until the docking station detects that the handheld device is removed from the docking station, or for a predetermined amount of time. According to an embodiment, the docking station 100 detects the pattern of the pulsed on/off cycling of handheld device 10 during the third time period 430, and conveys that information to a user via visual indicator 120.

According to an embodiment, the on/off or high/low timing pattern of the first time period 410 (start of charge), the second time period 420 (charging), and the third time period 430 (end of charge) differ from one another such that the docking station can detect which phase of charging is occurring. According to an embodiment, the docking station comprises a secondary induction coil whose signal changes corresponding with the on/off state of the handle. Thus the docking station can sense the presence and charging state of the handle, and the visual indicator on the docking station will cycle differently to indicate the charging state of the handle in the docking station (e.g.: starting charge, charging, ending charging, fully charged).

According to an embodiment, the visual indicator 120 of the docking station communicates a status of the handheld device 10 to the user. For example, the docking station can detect the unique pattern of the pulsed on/off cycling of handheld device 10 during the first time period 410, indicating that the handheld device is beginning to charge, and can communicate that status to the user, such as a lighted indicator, a red light, a flashing light, a pattern of lights, or any other visual indicator. When the docking station detects the unique pattern of the pulsed on/off cycling of handheld device 10 during the second time period 420, indicating that the handheld device is charging, the visual indicator can communicate that status to the user, such as a yellow light. When the docking station detects the unique pattern of the pulsed on/off cycling of handheld device 10 during the third time period 430, indicating that the handheld device is fully charged, the visual indicator can communicate that status to the user, such as a green light, among other visual indicators.

The duration of each of the time periods, and/or the unique pattern of the pulsed on/off cycling of during each of the time periods, can be controlled or regulated by controller 70. For example, controller 70 may initiate the initial pulsed on/off cycling during first time period 410, for a predetermined amount of time, such as 60 or 90 seconds. Accordingly, the controller 70 may include a timer or clock that tracks the predetermined amount of time. After the predetermined amount of time, the controller 70 can send a signal to transition the device to a charging cycle with a different timing, which can continue for the second time period 420 until the battery 80 in the handheld device 10 is fully charged. When the controller 70 detects that the handheld device is fully charged, the controller can send a signal to transition the device to a charging cycle with yet another unique pattern during third time period 430, which can continue until the docking station detects that the handheld device is removed from the docking station, or for a predetermined amount of time.

According to an embodiment, a unique pattern of the pulsed on/off cycling of handheld device 10 can communicate information other than the charge state of the handheld device. For example, the pattern can be unique for each of a plurality of different handheld devices, and can communicate the identity of the handheld device to the docking station. Thus, the docking station can be programmed or configured to recognize one or a plurality of different unique patterns associated with the identity of the oral cleaning device. Accordingly, a plurality of different cleaning devices can be utilized with the same docking station, and the docking station can recognize those cleaning devices differently. For example, the visual indicator of the docking station can be programmed or configured to communicate the detected identity of the oral cleaning device to the user.

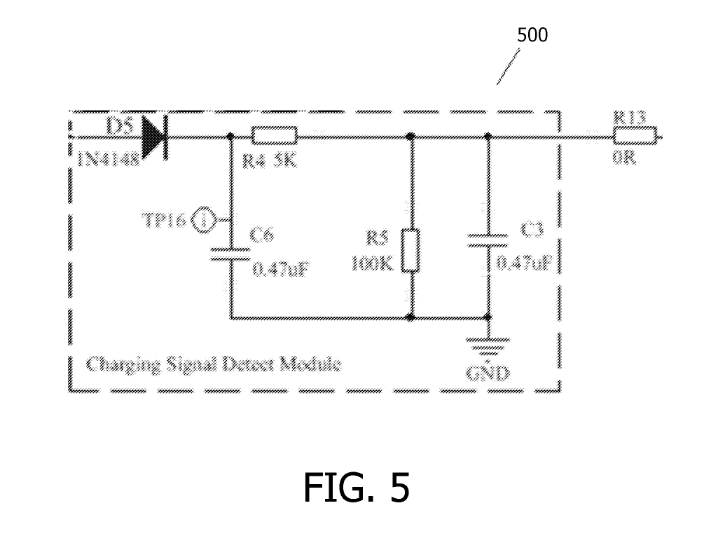

Referring to FIG. 5, in one embodiment, is a circuit diagram of a charging signal detection module 500 of the docking station 100, in accordance with an embodiment. Although FIG. 5 depicts one version of a circuit diagram of a charging signal detection module 500 of the docking station 100, many other variations are possible.

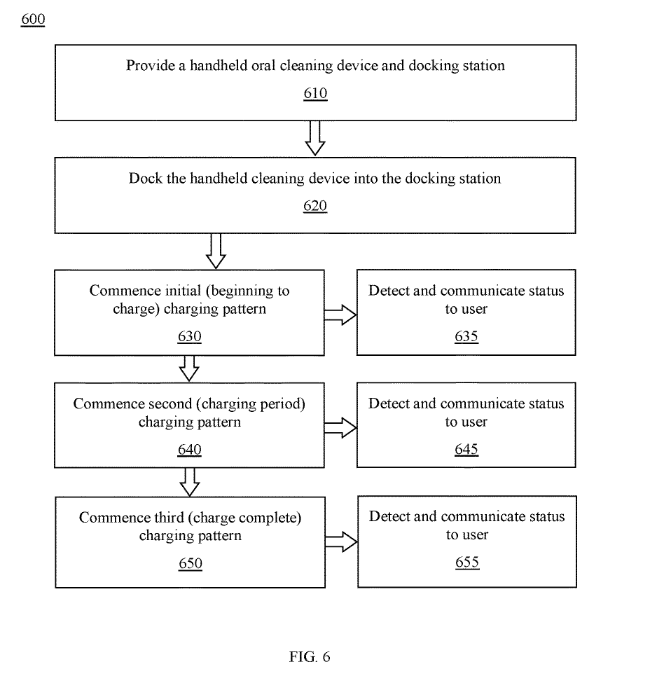

Referring to FIG. 6, in one embodiment, is a flowchart of a method 600 for communicating a status of a handheld oral cleaning device 10 to a docking station 100. At step 610 of the method, a handheld oral cleaning device 10 and a docking station 100 are provided. The handheld oral cleaning device is any of the devices described or otherwise envisioned herein. For example, the handheld oral cleaning device can include a handle 60, an elongated nozzle 30, an actuation button 50, a chamber 40 for a liquid, a power button 20, and/or a power/charge indicator 22. The docking station 100 is any of the docking station embodiments described or otherwise envisioned herein. For example, the docking station can include a reservoir 110 for holding a liquid 112, and a visual indicator 120.

At step 620 of the method, the user docks the handheld oral cleaning device 10 into docking station 100 such that inductive charging can occur. This can occur, for example, at the conclusion of every brushing or cleaning session, or periodically between a number of brushing or cleaning sessions.

At step 630 of the method, the handheld device 10 detects the inductive charging and commences an initial pulsed on/off cycling for a first time period 410 to indicate that the device is starting to charge. As just one example, this initial or start of charge on-off cycling pattern can continue for a predetermined time period, such as 60 seconds, after the handheld device is placed in the docking station, although it can be appreciated that numerous other timing cycles can be used, either longer or shorter than 60 seconds. The charge cycle can have a defined on/off timing cycle or pattern, such as the 200 ms on/high interval followed by a 100 ms low/off interval as shown in FIG. 4, although many other patterns are possible.

At step 635 of the method, the docking station 100 detects the unique pattern of the pulsed on/off cycling of handheld device 10 during the first time period 410, and conveys that information to a user via visual indicator 120. According to an embodiment, the charging mechanism of the docking station includes a secondary charging induction coil that has a signal that changes in conjunction with the defined on/off timing cycle or pattern received from the handheld device. According to an embodiment, the docking station 100 is programmed or configured to recognize the unique pattern of the pulsed on/off cycling of handheld device 10 during the first time period 410, and further programmed or configured to associate that unique pattern with a start of charging status visual indicator.

At step 640 of the method, after the end of the predetermined first time period, the handheld device 10 transitions to a charging cycle with different on/off timing, which can continue for a second time period 420 until the battery 80 in the handheld device is fully charged. As just one example, the charging cycle during second time period can be a 60 second charging cycle followed by a 50 ms off cycle, although other cycles with different timing are within the scope of the invention. According to an embodiment, the second time period will continue until the docking station detects that the handheld device is fully charged, or for a predetermined amount of time.

At step 645 of the method, the docking station 100 detects the unique pattern of the pulsed on/off cycling of handheld device 10 during the second time period 420, and conveys that information to a user via visual indicator 120. According to an embodiment, the docking station 100 is programmed or configured to recognize the unique pattern of the pulsed on/off cycling of handheld device 10 during the second time period 420, and is further programmed or configured to associate that unique pattern with a charging status visual indicator.

At step 650 of the method, when the handheld device is fully charged, the handheld device 10 will transition to an end of charge cycle during third time period 430, with a charging cycle with different on/off timing. As just one example, the charging cycle during third time period 430 can be a 200 ms on period with a 200 ms off cycle, although other cycles with different timing are within the scope of the invention. The third time period will continue until the docking station detects that the handheld device is removed from the docking station, or for a predetermined amount of time.

At step 655 of the method, the docking station 100 detects the unique pattern of the pulsed on/off cycling of handheld device 10 during the third time period 430, and conveys that information to a user via visual indicator 120. According to an embodiment, the docking station 100 is programmed or configured to recognize the unique pattern of the pulsed on/off cycling of handheld device 10 during the third time period 430, and is further programmed or configured to associate that unique pattern with a charging status visual indicator.

With step 650 the handheld charging device is fully charged, and can be used by the user for one or more brushing or cleaning sessions.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. An oral cleaning system comprising:
a handheld oral cleaning device, the device comprising a controller configured to initiate a charging cycle having a unique ON/OFF timing interval charging pattern for each of a plurality of different charging states; and
a docking station configured to receive the handheld oral cleaning device, the docking station comprising a secondary induction coil configured to detect the unique ON/OFF timing interval charging pattern of the charging cycle for each of the plurality of different charging states, and further comprising a visual indicator configured to indicate, based on the detected charging cycle, one of the plurality of different charging states of the battery of handheld oral cleaning device.

2. The oral cleaning system of claim 1, wherein the plurality of different charging states of the handheld oral cleaning device includes at least one of a start of charge state, a charging state, and an end of charge state.

3. (canceled)

4. The oral cleaning system of claim 1, wherein the visual indicator provides a different indication for each of the plurality of different charging states of the handheld oral cleaning device.

5. The oral cleaning system of claim 4, wherein the visual indicator illuminates with a different color for each of the plurality of different charging states of the handheld oral cleaning device.

6. The oral cleaning system of claim 1, wherein the handheld oral cleaning device comprises a charging mechanism, the charging mechanism comprising an induction coil configured to generate the unique charging cycles.

7. The oral cleaning system of claim 1, wherein the docking station further comprises a liquid reservoir.

8. A docking station configured to receive a handheld oral cleaning device, the docking station comprising:
a liquid reservoir;
a charging mechanism configured to charge the handheld oral cleaning device, the charging mechanism comprising a secondary induction coil configured to detect a unique ON/OFF timing interval charging pattern of the charging cycle for each of a plurality of different charging states of the handheld oral cleaning device; and
a visual indicator configured to indicate, based on the detected charging cycle, one of the plurality of different charging states of the handheld oral cleaning device.

9. The docking station of claim 8, wherein the plurality of different charging states of the handheld oral cleaning device includes at least one of a start of charge state, a charging state, and an end of charge state.

10. (canceled)

11. The docking station of claim 8, wherein the visual indicator is configured to provide a different indication for each of the plurality of different charging states of the handheld oral cleaning device.

12. The oral cleaning system of claim 11, wherein the visual indicator is configured to illuminate with a different color for each of the plurality of different charging states of the handheld oral cleaning device.

13. A handheld oral cleaning device configured to be charged when docked with a docking station, the handheld oral cleaning device comprising:
a handle;
a liquid reservoir;
a charging mechanism; and
a controller in communication with the charging mechanism, the controller configured to initiate a charging cycle having a unique ON/OFF timing interval charging pattern for each of a plurality of different charging states, wherein the plurality of different charging states comprises at least one of a start of charge state, a charging state, and an end of charge state.

14. (canceled)

15. The handheld oral cleaning device of claim 13, wherein the device is further configured to communicate the generated unique charging cycle to the docking station via the charging mechanism.
